(19) United States
(12) Patent Application Publication
(10) Pub. No.: US 2022/0178422 A1
(43) Pub. Date: Jun. 9, 2022

(54) CABLE CARRIER AND PROCESSING MACHINE HAVING A CABLE CARRIER

(71) Applicant: TRUMPF Laser- und Systemtechnik GmbH, Ditzingen (DE)

(72) Inventors: Gunter Fischer, Moensheim (DE); Martin Blaser, Vogt (DE)

(21) Appl. No.: 17/603,066

(22) PCT Filed: Apr. 3, 2020
(86) PCT No.: PCT/EP2020/059621

§ 371 Date: Oct. 12, 2021

(30) Foreign Application Priority Data
Apr. 12, 2019 (DE) 10 2019 109 747.9

(51) Int. Cl. F16G 13/16; H02G 11/00

(52) U.S. Cl. CPC F16G 13/16; B23K 26/127; H02G 11/006

(57) ABSTRACT

A cable carrier has a plurality of mutually articulated chain links and a working chamber extending in the longitudinal direction of the chain. In the working chamber the at least one supply line is guided in the longitudinal direction of the chain. Each chain link is formed from two lateral elements which are opposite each other and two elongate support webs which are opposite each other. A hollow profile of the chain link is formed by the lateral elements and the support webs. At least one special chain link is provided between two chain links. The special chain link has a cross-section with a lower height than the other chain links.

The invention relates to a cable carrier for a processing machine for processing sheet-like workpieces and to a processing machine having a cable carrier.

A cable carrier for a processing machine for processing workpieces is known from WO 2016/131964 A1. This cable carrier comprises a plurality of chain links connected to one another in an articulated fashion, wherein one of the two sides of the cable carrier is covered with an elastically bendable strip which is retained on at least some chain links and is guided displaceably in the longitudinal direction of the cable carrier. This cover strip preferably extends beyond the chain links on both sides in the transverse direction of the cable carrier. A gap situated between an installed cable carrier and a guide groove can consequently be covered at least in the region of housing walls and/or doors positioned above, as a result of which the risk of contamination can be reduced. The risk of the escape of laser radiation can moreover be minimized and hence the laser safety improved.

The object of the invention is to propose a cable carrier and a processing machine having a cable carrier which have a cost-effective design and in which the risk of the escape of laser radiation with an installed cable carrier is minimized.

This object is achieved by a cable carrier in which at least one special chain link, which has a cross-section of reduced height compared with the chain links adjacent to the special chain link, is provided between two chain links. With respect to a housing wall of the processing machine or a sliding door of the housing of the processing machine, this cable carrier is positioned in such a way that the special chain link lies between the ground and the housing wall or on the ground, within the path traveled by the sliding door. By virtue of the cross-section of reduced height, the total height of the special chain link is reduced. As a result, it can be provided that, for example, the sliding door can pass over the special chain link. Such a sliding door of the housing has a protective curtain, facing downward, in particular in the form of bristles which pass over the special chain link in the region of its reduced height. The cable carrier preferably lies on the ground on which the processing machine or the housing is placed.

It is preferably provided that the special chain link has, opposite a bearing surface, a channel which is oriented so that it is open at the top and extends transversely to the longitudinal direction of the cable carrier. It is consequently made possible that the cable carrier lies flat on the ground with the chain links and the special chain link, and a channel extending transversely to the longitudinal direction of the cable carrier is formed in the special chain link with a reduced structural height. It is consequently made possible for the door to pass over it in order to open and close the housing or also to simplify the leading out of the cable carrier at a stationary wall section of the housing of the processing machine.

The underside of the special chain link preferably lies within the plane of the at least one support web of the neighboring chain link. It is consequently also made possible that a completely flat surface is provided in the working space of the cable carrier between the chain links and the special chain link in order to guide at least one power supply line.

The special chain link is preferably tapered heightwise in such a way that a tapered interior space is formed which extends between an underside or a lower support web of the special chain link and a neutral fiber or below a neutral fiber. The neutral fiber of the chain links lies in a line connecting articulated joints between the individual chain links. A particularly low passage height or structural height can consequently be obtained.

A further advantageous embodiment of the special chain link provides that a light-protection section, which extends outward over the width of the chain links adjoining the special chain link on both sides, is provided at at least one end of the channel. By means of this light section which preferably has the same height as the channel, the channel is, as it were, elongated and enables additional screening from the escape of laser radiation to be obtained. When bristles on the sliding door pass over the channel, the bristles are angled in the region of the channel base and, after passing over the channel base, are oriented essentially directly downward onto the ground. An opening gap can be formed in between, through which laser radiation can escape. This is closed by the light-protection sections.

A further preferred embodiment of the cable carrier provides that the channel of the special chain link has a U-shaped design and lead-in slopes are provided at the respective ends of the channel. Introduction of the protective curtain of the sliding door into the channel can consequently be facilitated. It is in particular provided that a light-protection section, which extends beyond the width of the chain link, is provided at one end of the side wall of the channel and the lead-in slope is formed on this light-protection section, adjoining it on the outside.

It is furthermore preferably provided that the channel has at each end a run-on surface which extends from a bearing surface of the special chain link to the channel base. Simplified sliding of the shielding curtain of the sliding door can consequently be provided.

The channel base can advantageously have a length which is smaller than the distance between two opposite side elements of the neighboring chain links. As a result, although the interior space which is available for guiding the power supply lines has a reduced width, improved protection from the escape of laser radiation is consequently enabled because the light-protection section can act with a larger surface area in the region of the run-on surface.

It is furthermore preferably provided that, viewed in the longitudinal direction of the cable carrier, side elements of the special chain link which are connected in an articulated fashion to the respective neighboring chain links are provided before and after the channel. As a result, the special chain link or links can be integrated in an articulated fashion between two conventional chain links, as a result of which a deflection radius of the chain links can be almost completely maintained.

The special chain link preferably has, adjoining the interior space of reduced height, guide elements which extend in and counter to the longitudinal direction of the cable carrier. These guide elements are inclined in the direction of deflection of the chain links. These guide elements are preferably oriented flush with the underside of the channel base. As a result, kinking of the power supply lines is prevented when the cable carrier is deflected.

A further preferred embodiment of the cable carrier provides that the at least one power supply line is fastened in or neighboring an axis of articulation between the special chain link and the neighboring chain link. This arrangement has the advantage that the at least one power supply line is guided close to or in the neutral fiber and a relative movement at the respective end of the cable carrier is minimized. It can alternatively be provided that the at least one power supply line is fixed in the tapered interior space.

It is furthermore preferably provided that the at least one power supply line is guided loosely at a run-in or run-off side end of the cable carrier. It is consequently ensured that the at least one power supply line is guided stresslessly, i.e. with no tensile and/or compressive stress, during a deflection movement of the cable carrier.

It is furthermore preferably provided that pivot-limiting elements are provided at the side walls, open at the top, of the channel of the special chain link in and counter to the longitudinal direction of the cable carrier. These pivot-limiting elements are oriented and angled in the direction of the neighboring conventional chain link in such a way that the same pivot angle is assumed between the special chain link and the neighboring conventional chain link as between two conventional chain links, or, if the length of the special link differs from the conventional chain link, the pivot angle is configured such that the length of the cable situated inside the special link during the pivoting ideally corresponds to the length of the neutral fiber.

The special chain link is preferably formed from a metal material, in particular steel sheet metal. This has the advantage that low wall thicknesses can be used, as a result of which, on the one hand, the passage height in the channel base is reduced and, on the other hand, a still sufficient height of the tapered interior space can be obtained.

In the embodiment of the special chain link made from a metal material, a terminal for a protective conductor or neutral conductor is preferably provided on the special chain link, in particular lying inside it. This terminal serves to ground the cable carrier and hence to keep personnel safe in the event of a fault or a possible broken cable.

The object on which the invention is based is furthermore achieved by a processing machine for processing a workpiece, in particular sheet-like material, in which, in a processing station in which a processing beam is directed onto the workpiece by a processing head, a palette can be introduced which has a workpiece support for receiving the sheet-like workpiece and the palette can be moved between the processing station and a loading and unloading station, and the processing station is enclosed by a housing which has at least one sliding door for the processing station, wherein a cable carrier is fixed with one end in the processing station or in the loading and unloading station and is fixed with the other end on the movable palette, and a special chain link of the cable carrier, which has a cross-section of reduced height compared with the neighboring chain links, is provided in the path traveled by the sliding door of the housing. Simple opening and closing of the door is consequently enabled with an installed cable carrier. The palette can be moved between the loading and unloading station, on the one hand, and the processing station, on the other hand. When the palette is positioned both in the processing station and in the loading and unloading station, the escape of laser radiation from the processing station can be minimized or even completely prevented when the door is closed. This cable carrier can also be used with stationary walls of a housing in order to guide power supply cables from outside the housing inside it to a processing machine.

The invention and further advantageous embodiments and developments are described and explained in detail below with the aid of the examples shown in the drawings. The features which can be extracted from the description and the drawings can be applied according to the invention individually or multiply in any combination. In the drawings:

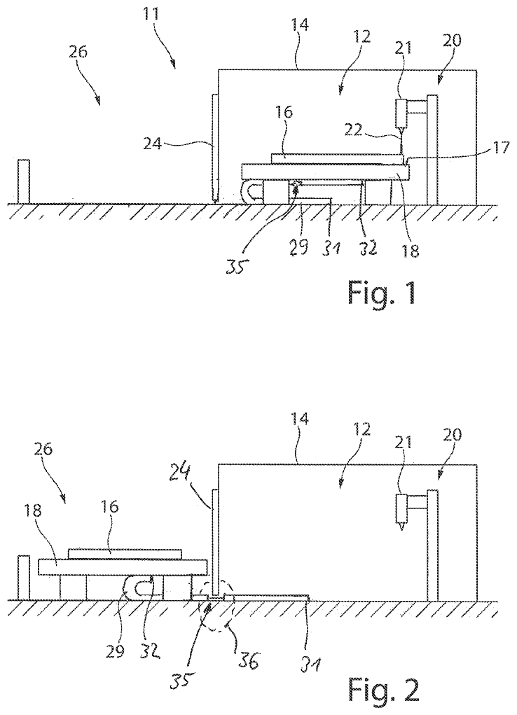

FIG. 1 shows a schematic side view of a processing machine with a housing and a palette in a processing station,

FIG. 2 shows a schematic side view of the processing machine according to FIG. 1 with the palette in a loading and unloading station,

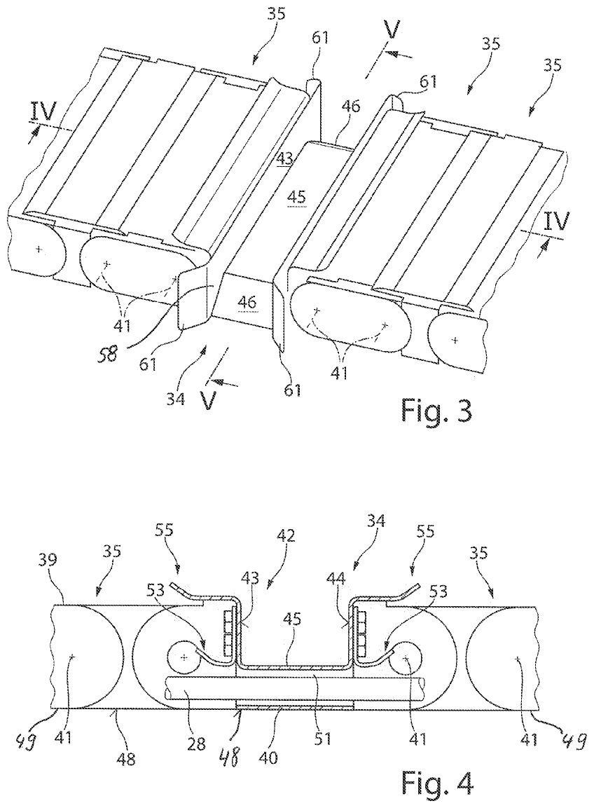

FIG. 3 shows a perspective view of a cable carrier with chain links and a special chain link,

FIG. 4 shows a schematic view in section along the line IV-IV in FIG. 3,

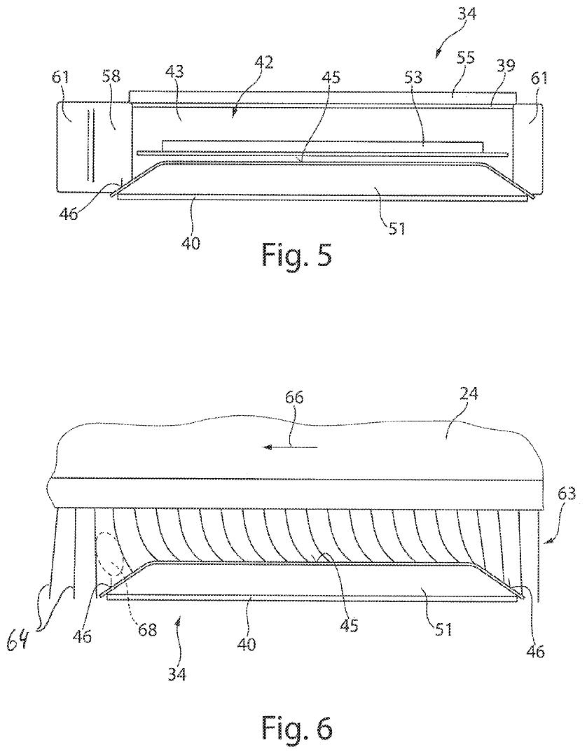

FIG. 5 shows a schematic view in section along the line V-V in FIG. 3,

FIG. 6 shows a schematic view of a protective curtain of a door in the special chain link,

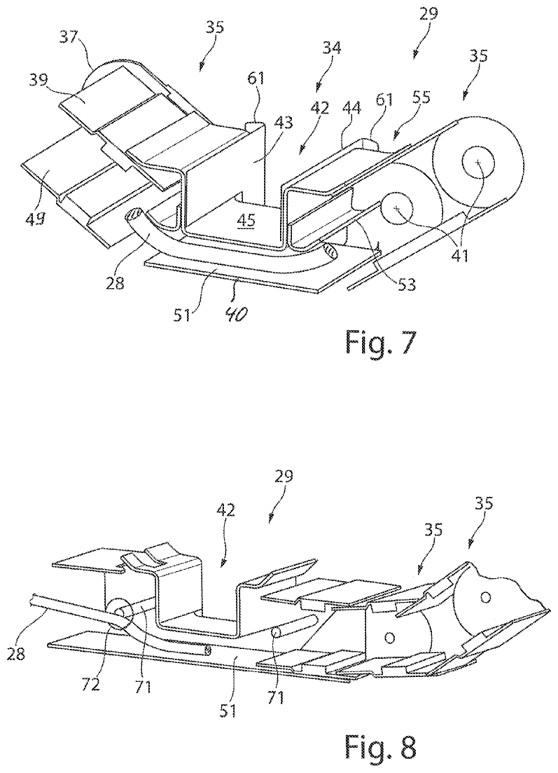

FIG. 7 shows a perspective view of the special chain link with neighboring chain links in an angled position, and

FIG. 8 shows a perspective view in section of an alternative embodiment of the special chain link in FIG. 7.

A schematic side view of a processing machine 11 for cutting sheet-like materials is shown in FIG. 1. A processing station 12 of the processing machine 11 is surrounded by the housing 14. A sheet-like material 16 is processed in the processing station 12 by means of a cutting beam 22. The sheet-like material 16 lies on a workpiece support 17 which is provided on a movable palette 18. A linear axis system 20, which accommodates a processing head 21 for emitting a cutting beam 22, is provided inside the processing station 12. This processing head 21 can be moved by the linear axis system 20 in two or three dimensions relative to the sheet-like material 16. This processing machine 11 can be formed, for example, as a laser cutting machine such that a laser cutting beam is emitted by the processing head 21. Alternatively, the processing machine 11 can also be formed as a plasma cutting machine or a punch-laser combination machine.

The housing 14 is designed as an occupational safety means and serves in particular to minimize or ideally completely prevent the escape of laser radiation. A door 24, which is horizontally or vertically slidable, movable, or shiftable in order to open the housing 14, is provided in the housing 14. When the door 24 is open, the palette 18 can be moved from the processing station 12 into a loading and unloading station 26 arranged next to it. This position is shown in FIG. 2.

At least one power supply line 28, which is accommodated in a cable carrier 29, is provided for the purpose of supplying energy to the movable palette 18. This cable carrier 29 is preferably fixed at one end in the processing station 12. The other end 32 of the cable carrier 29 is fixed on the movable palette 18. The path traveled by the cable carrier 29 from the loading and unloading station 26 to the processing station 12 crosses the housing 14, in particular the opening door 24. The cable carrier 29 comprises at least one special chain link 34 which is accommodated between conventional chain links 35. This special chain link 34 is positioned at the crossing point 36 of the cable carrier 29 and the door 24 or a wall of the housing 14. This crossing point 36 is shown in FIG. 2. The risk of laser radiation escaping at the crossing point 36 can be minimized or ideally completely prevented by the special chain link 34 which is integrated into the cable carrier 29.

A perspective view of the cable carrier 29 is shown in FIG. 3. The cable carrier 29 consists of a plurality of chain links 35 connected to one another in an articulated fashion and a special chain link 34 arranged between two chain links 35. A schematic view in section of the special chain link 34 along the line IV-IV is shown in FIG. 4. A further view in section along the line V-V is shown in FIG. 5.

The chain links 35, which are generally known, have two opposite side elements 37, 38 which are spaced apart from each other by two opposite elongated support webs 39, 49. The side elements 37, 38 and the support webs 39, 49 form a hollow profile. An articulated connecting element is provided in each case on the side elements 37, 38 in order to receive a neighboring chain link in an articulated fashion. The resulting axes of articulation 41 are illustrated schematically. The individual hollow profiles, arranged in a row, form a working space of the cable carrier 29 in which the at least one power supply line 28 is guided.

The special chain link 34 comprises a channel 42 which is open on one side at the top. This channel 42 is formed by side walls 43, 44 which are preferably oriented vertically. A channel base 45 extends between the side walls 43, 44. Run-on slopes 46, which extend from a bearing surface 48 of the cable carrier 29 as far as the channel base 45, are provided on the run-in and run-off side of the channel 42. The bearing slope 46 preferably merges flush with the channel base 45. The channel base 45 is arranged depressed relative to an upper support web 39 of the chain link 35. A tapered interior space 51 is formed between a lower support web 40 of the special chain link 34 and the channel base 45. This tapered interior space 51 has a smaller height than the hollow profile of the chain links 35. The tapered interior space 51 preferably has a height such that at least one power supply line 28 can be guided through without any clamping in the longitudinal direction of the cable carrier 29.

Guide elements 53 are arranged on an inner side of the side walls 43, 44 of the special chain link 34. These guide elements 53 extend in and counter to the longitudinal direction of the cable carrier. The guide elements 53 are furthermore formed so they are curved. This curvature is oriented upward relative to a support surface 48 of the cable carrier 29. As a result, the at least one power supply line 28 can be guided when deflected and protected from kinking.

Pivot-limiting elements 55 are provided at the upper ends of the side walls 43, 44. They are oriented in a similar fashion to the guide elements 53 in and counter to the longitudinal direction of the cable carrier. These pivot-limiting elements 55 are oriented upward relative to a bearing surface 48 of the cable carrier 29. When the cable carrier 29 is deflected, the pivot angle between the special chain link 34 and the chain link 35 immediately neighboring the latter is limited.

A light-protection section 58 is provided at at least one end of the channel 52. This light-protection section 58 is illustrated, for example, in a side view in FIG. 5. This light-protection section 58 can also be provided on both ends of the channel 42. The light-protection section 58 preferably represents an elongation of the side wall 43, 44 and projects beyond the width of the chain links 35 neighboring the special chain link 34. The light-protection section 58 also preferably extends at least over the length of the run-on slope 46.

A lead-in slope 61 can be provided at the free end of the light-protection section 58. It is oriented so that it widens outward relative to the width of the channel 42. At the opposite end of the channel 42, the lead-in slope 61 can also directly adjoin the side wall 43, 44 or be integrally formed thereon.

The functioning of the special chain link 34 in conjunction with a horizontally sliding door 24 of the housing 14 is illustrated in FIG. 6.

The door 24 has a protective curtain 63, which preferably consists of a plurality of bristles 64, at a lower end. The processing station 12 can consequently be shielded between the door 24 and the ground.

When the door 24 closes, after the palette 18 has been moved into the processing station 12, the protective curtain 63 is guided inside the channel 42. At the entry side of the channel 42, the bristles 64 slide on the run-on slopes 26 and are guided along the channel base 45 in the closing direction of the door 24 according to arrow 66 by means of an oblique position of a curved position. Some of the bristles 64 come free from the channel base 45 at the run-off side end of the channel 42. Other bristles 64 still lie on the channel base 45 or on the run-off slope 46, as a result of which an opening region 68 is produced which is illustrated in dashed lines. Laser radiation can escape through this opening region 68. For the purpose of preventing such an escape, the light-protection section 58 is provided on both sides as an elongation of the channel 42 in order to cover and shield this opening region 68.

A schematic view in section of the cable carrier 29 according to FIG. 4 in a deflected position is illustrated in FIG. 7. It is clear therefrom that the pivoting movement of the respective chain link 35 adjoining the special chain link 34 is limited by the pivot-limiting element 55. An upper support web 39 of the chain link 35 lies on the pivot-limiting element 55. In this embodiment, the power supply line 28 can be fixed in the tapered interior space 51. This can be effected, for example, by holding chambers, which extend along the support webs 40 and hold the individual or multiple power supply lines 28 clamped, being formed in the tapered interior space 51. Kinking of the power supply line when the cable carrier 29 is deflected is prevented by the respective guide element 53.

An alternative embodiment of the cable carrier 29 in FIG. 7 is illustrated in FIG. 8. It is provided in this embodiment that a connecting rod 71 is provided in the axis of articulation 41 of the chain link 35 and the special chain link 34. This connecting rod 71 lies in the neutral fiber of the chain links. This neutral fiber of the chain links 35 is formed by a connecting line along the respective longitudinal axis. The power supply line 38 can be held and guided in this neutral fiber with no tensile or compressive stress.

In the embodiment illustrated in FIG. 8, it is preferably provided that the at least one power supply line 28 is fastened on the connecting rod 71. This can be effected, for example, by a cable tie 72. The power supply line 28 is thus fastened on the respective connecting webs 71 before and after the channel 42 and thus held firmly relative to the special chain link 34. The at least one power supply line 28 is guided loosely at the respective end of the cable carrier 29. In order to adjust the length, the at least one power supply line 28 can advantageously be held in the hollow profile such that it forms a serpentine line in some places.

The special chain link 34 is preferably formed from a metal material, in particular from sheet metal. A high degree of stiffness can be obtained as a result. At the same time, it is made possible to form reduced wall thicknesses. As a result, on the one hand, the height of the channel 42 and, on the other hand, the tapered interior space 51 can in each case be formed maximally.

It can furthermore alternatively be provided that the special chain link 34 is formed in two or more parts. An articulated connection is advantageously provided in the transition region between the channel base 45 and a side wall 43, 44. Alternatively, an articulated connection can also be provided in the channel base 45. Such an arrangement is in particular provided when an enlarged channel width is required.

1-15. (canceled)

16. A cable carrier, comprising:
a plurality of chain links connected to one another in an articulated fashion and defining a working space extending in a longitudinal direction of the cable carrier and in which at least one power supply line is guided in the longitudinal direction of the cable carrier;
each of said chain links being formed from two opposite side elements and two opposite elongated support webs, with said side elements and said support webs forming a hollow profile of the respective said chain link; and
at least one special chain link disposed between two chain links, said at least one special chain link having a cross-section with a reduced height compared with a height of said two chain links.

17. The cable carrier according to claim 16, wherein said special chain link has a bearing surface and a channel opposite said bearing surface, and wherein said channel is oriented upward and is upwardly open and extends transversely to the longitudinal direction of the cable carrier.

18. The cable carrier according to claim 17, wherein a support web of said special chain link faces a bearing surface and lies in a plane of a lower support web of the neighboring said chain links.

19. The cable carrier according to claim 17, wherein an interior space of said special chain link has a tapering height and extends between the bearing surface and a neutral fiber or below a neutral fiber which is formed by a connecting line which extends along axes of articulation of at least two neighboring said chain links.

20. The cable carrier according to claim 19, which further comprises a light-protection section disposed at at least one end of said channel of said special chain link.

21. The cable carrier according to claim 20, wherein said light-protection section extends outwardly beyond a width of an adjoining said chain link.

22. The cable carrier according to claim 17, wherein said channel of said special chain link is formed with a lead-in slope at a respective end of said channel.

23. The cable carrier according to claim 17, wherein said channel of said special chain link has at each end a run-on slope which extends from a bearing surface of said special chain link as far as a channel base of said channel.

24. The cable carrier according to claim 23, wherein said channel base has a length that is smaller than a distance between respectively opposite side elements of said special chain link and the neighboring said chain links.

25. The cable carrier according to claim 17, wherein, viewed in the longitudinal direction of the cable carrier, side elements of said special chain link which are connected in an articulated fashion to the respective neighboring said chain links extend before and after said channel.

26. The cable carrier according to claim 16, which further comprises a guide element disposed adjoining the interior space of reduced height and counter to the longitudinal direction of the cable carrier.

27. The cable carrier according to claim 26, wherein said guide element is curved in a direction of deflection of said chain links.

28. The cable carrier according to claim 16, wherein at least one power supply line is fastened in or next to an axis of articulation between said special chain link and an adjoining said chain link or in an interior space of said special chain link having a tapering height.

29. The cable carrier according to claim 28, wherein the at least one power supply line is guided loosely at a run-in side and/or run-off side end of the cable carrier.

30. The cable carrier according to claim 17, which further comprises pivot-limiting elements provided on side walls of said channel which are open at the top, and project in and counter to the longitudinal direction of the cable carrier.

31. The cable carrier according to claim 16, wherein said special chain link is formed from a metal material.

32. The cable carrier according to claim 31, wherein said special chain link is formed from sheet metal.

33. The cable carrier according to claim 31, wherein said special chain link is formed with a terminal for a neutral conductor.

34. A processing machine for processing a workpiece, the processing machine comprising:
a processing station having a processing head configured to direct a processing beam onto the workpiece;
a palette having a workpiece support for receiving the workpiece and being movable between said processing station and a loading and unloading station;
a housing enclosing said processing station, said housing having at least one door for access to said processing station;
a cable carrier having one end affixed in said processing station or in the loading and unloading station and another end affixed at said movable palette, and said cable carrier having a special chain link in an opening region of said door, said special chain link having a cross-section of reduced height compared with a height of respectively neighboring chain links.
